(19) United States
(12) Patent Application Publication
(10) Pub. No.: US 2003/0190176 A1
(43) Pub. Date: Oct. 9, 2003

(54) Fixing device and image forming apparatus equipped therewith

(75) Inventors: Hajime Tanaka, Hachioji-shi (JP); Hidetoshi Katayanagi, Nakano-ku (JP); Toshiki Hayami, Hachioji-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Konica Corporation, Tokyo (JP)

(21) Appl. No.: 10/401,448

(22) Filed: Mar. 28, 2003

(30) Foreign Application Priority Data
Apr. 4, 2002 (JP) JP2002-102313

(51) Int. Cl. G03G 15/20

(52) U.S. Cl. 399/328; 399/333; 399/406

(57) ABSTRACT

A fixing device includes; a heat roller having a cylindrical core with a heating source provided inside, an elastic body lined around the core, and a mold releasing layer covering the surface of the elastic body, and a pressure roller in pressure contact with the heat roller. A toner image is fixed by sandwiching, heating and pressurizing of the transfer material where the unfixed toner image fed to the pressed nip of the two aforementioned rollers is transferred. The hardness of the pressure roller is set higher than that of the heat roller, and the reference in Asker C hardness is set from 10 to 15°.

### BACKGROUND OF THE INVENTION

The present invention relates to a fixing device and an electrophotographic image forming apparatus equipped with such a fixing device, wherein the fixing device protects fixing performance against possible deterioration caused by winding of a transfer material when toner is fixed on the transfer material.

According to the prior art, toner fused on the transfer material at the time of fixing sticks to a heat roller, and winding is caused by separation failure in some cases. To solve the problem, an oil coating device, for example, is provided so that good separability is ensured even in the case of a flat nip. However, the oil coating mechanism equipped with an oil roller and related parts contain many replacements parts that require replacement work on a periodic basis. The has resulted in troublesome handling and hence waste of time, with the result that printing cost per sheet has to be increased.

The object of the present invention is to solve such a problem and to provide a fixing device and an image forming apparatus equipped therewith, wherein the fixing device is characterized by stable fixing performances and reduced printing cost without transfer material being contaminated by oil, free from troublesome handling of an oil coating device or replacement of parts.

The aforementioned object can be achieved by any one of the following structures (1) through (3):

(1). A fixing device comprising; a heat roller comprising a cylindrical core with a heating source provided inside, an elastic body lined around the core, and a mold releasing layer covering the surface of the elastic body, and a pressure roller in pressure contact with the heat roller; wherein toner image is fixed by sandwiching, heating and pressurizing of the transfer material where the unfixed toner image fed to the pressed nip of the two aforementioned rollers is transferred. The fixing device is further characterized in that the hardness of the aforementioned pressure roller is set higher than that of the heat roller, and the difference in Asker C hardness is set from 10 to 15°. The Asker C hardness represents a surface hardness of a roller peripheral surface under a total load of 1 kg of an Asker C hardness meter made by Kobunshi Keiki Co. (2). An image forming apparatus equipped with the fixing device described in (1). (3). An image forming apparatus described in (2) with a sheet curl correction device (hereinafter, also referred to as a flattener) provided downstream of the aforementioned fixing device for flattening a sheet which is bent to be convex upward.

### BRIEF DESCRIPTION OF THE DRAWINGS

FIG. 1 is a cross sectional view of a fixing device and an image forming apparatus equipped therewith as an embodiment of the present invention;

FIG. 2 is a cross sectional view showing the configuration of a heat roller and pressure roller used in the fixing device according to the present invention; and

FIG. 3 is a cross sectional view representing the fixing device according to the present invention and a sheet curl correction device located downstream thereof.

The following describes the embodiment of the present invention. It should be noted that the following description is not intended to define the technical scope of the aforementioned structures or meanings of the related terminologies. The following fragmentary explanation of the embodiment according to the present invention is based on the best mode, without being restricted to the meaning of the terminologies or technical scope.

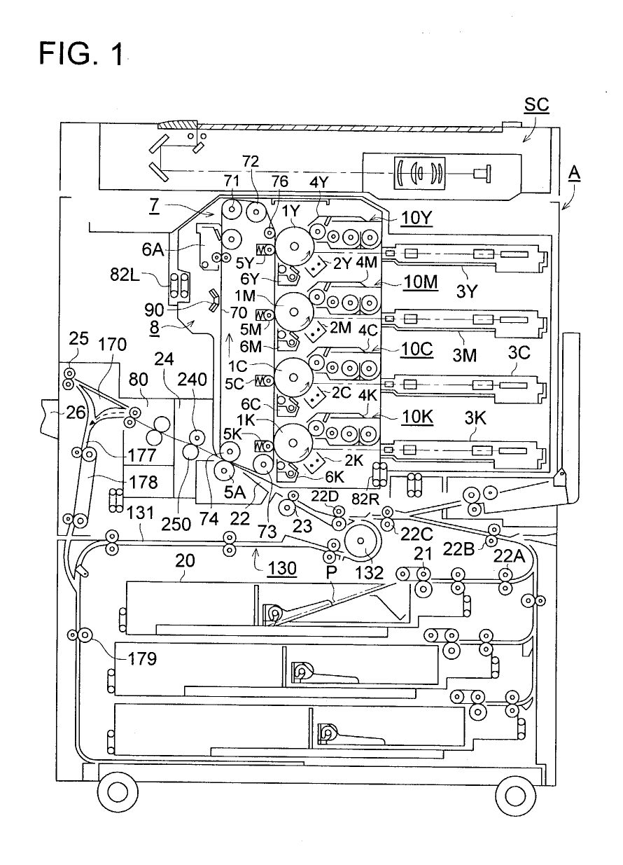

FIG. 1 is a cross sectional view of an fixing device and a color image forming apparatus as an image forming apparatus equipped therewith as an embodiment of the present invention.

The color image forming apparatus corresponds to what is called a tandem type color image forming apparatus. It is composed of plural sets of image forming units 10Y, 10M, 10C and 10K, an endless belt-shaped intermediate transfer unit, a paper feeding and conveying means 21 and a fixing device 24. A document image reader SC is mounted on the top of the main body A of the image forming apparatus.

The image forming unit 10Y for forming a yellow image has electrostatic charging means 2Y arranged around the drum-like photoconductor 1Y as a first image carrier, exposure means 3Y, development means 4Y, a primary transfer roller 5Y as primary transfer means, and cleaning means 6Y. The image forming unit 10M for forming a magenta image has a drum-like photoconductor 1M as a first image carrier, electrostatic charging means 2M, exposure means 3M, development means 4M, a primary transfer roller 5M as primary transfer means, and cleaning means 6M. The image forming unit 10C for forming a cyan image has a drum-like photoconductor 1C as a first image carrier, electrostatic charging means 2C, exposure means 3C, development means 4C, a primary transfer roller 5C as primary transfer means, and cleaning means 6C. The image forming unit 10K for forming a black image has a drum-like photoconductor 1K as a first image carrier, electrostatic charging means 2K, exposure means 3K, development means 4K, a primary transfer roller 5K as primary transfer means, and cleaning means 6K.

The endless belt-shaped intermediate transfer unit 7 has an endless belt-shaped intermediate transfer body 70 as a semi-conductor endless belt-shaped secondary image carrier that is wound and supported rotatably by plural rollers.

The images of various colors formed by image forming units 10Y, 10M, 10C and 10K are sequentially transferred onto the rotating endless belt-shaped intermediate transfer body 70 by primary transfer rollers 5Y, 5M, 5C and 5K, whereby a composite color image is created. The transfer material P as a recording medium stored in the paper feeding cassette 20 is fed by the paper feeding means 21, and is conveyed to a secondary transfer means 5A through a plurality of intermediate rollers 22A, 22B, 22C and 22D, and a registration roller 23. Then color images are collectively transferred onto the transfer material P. The transfer material with color image transferred thereon is subjected to fixing process by a fixing device 24. As occasion demands, it is sandwiched by ejection rollers 25 through a flattener 80 and is placed onto an ejection tray 26.

The above description illustrates how an image is formed on one side of the transfer material P. In duplexing mode, an ejection switching member 170 operates to open a paper guide 177, and transfer material P is conveyed in the direction of an arrow with a broken line.

The transfer material P is fed downward by a feed mechanism 178, and is switched back by a paper reversing device 179. The trailing end of transfer material P is conveyed into the duplexing paper supply unit 130 as a leading edge.

A conveyance guide 131 arranged on the paper supply unit 130 for duplexing is fed in the direction of paper supply, and the transfer material P is supplied again by means of a paper supply roller 132 and is led to the conveyance path 22.

The transfer material P is fed again to the secondary transfer position in the manner as stated above, and toner image is transferred onto the back surface of the transfer material P and fixed in place by means of the fixing device 24. After that, paper is ejected into the ejection tray 26.

Color image is transferred to the transfer material P by secondary transfer means SA, and the transfer material P is subjected to curvature separation by an endless belt-shaped intermediate transfer body 70. Then residual toner is removed from the endless belt-shaped intermediate transfer body 70 by cleaning means 6A.

During the image formation process, a primary transfer roller 5K is kept in pressure contact with a photoconductor 1K at all times. Other primary transfer rollers 5Y, 5M and 5C are brought in pressure contact with the respective corresponding photoconductors 1Y, 1M and 1C during image formation alone.

The secondary transfer means 5A is kept in pressure contact with the endless belt-shaped intermediate transfer body 70 only during the process of secondary transfer with the passage of the transfer material P.

Arrangement is designed to allow an enclosure 8 to be pulled out from the apparatus main body A through support rails 82L and 82R.

The enclosure 8 is composed of image forming units 10Y, 10M, 10C and 10K and an endless belt-shaped intermediate transfer unit 7.

Image forming units 10Y, 10M, 10C and 10K are arranged in series in the vertical direction. The endless belt-shaped intermediate transfer body 7 is provided on the left side of photoconductors 1Y, 1M, 1C and 1K in the drawing. The endless belt-shaped intermediate transfer body 7 is composed of an endless belt-shaped intermediate transfer body 70 rotatable around the rollers 71, 72, 73 and 74, primary transfer rollers 5Y, 5M, 5C and 5K, and a cleaning means 6A.

The image forming units 10Y, 10M, 10C and 10K and an endless belt-shaped intermediate transfer unit 7 are integrally pulled out of the main body A by the draw-out operation of the enclosure 8.

The support rail 82L illustrated on the left of the enclosure 8 is arranged in the upward space of the fixing device 24 on the left of the endless belt-shaped intermediate transfer body 70. The support rail 82R illustrated on the right of the enclosure 8 is arranged close to the lower position of the development means 4K located at the lowest position. The support rail 82R is located where it does not interfere with mounting and dismounting of development means 4Y, 4M, 4C and 4K from the enclosure 8.

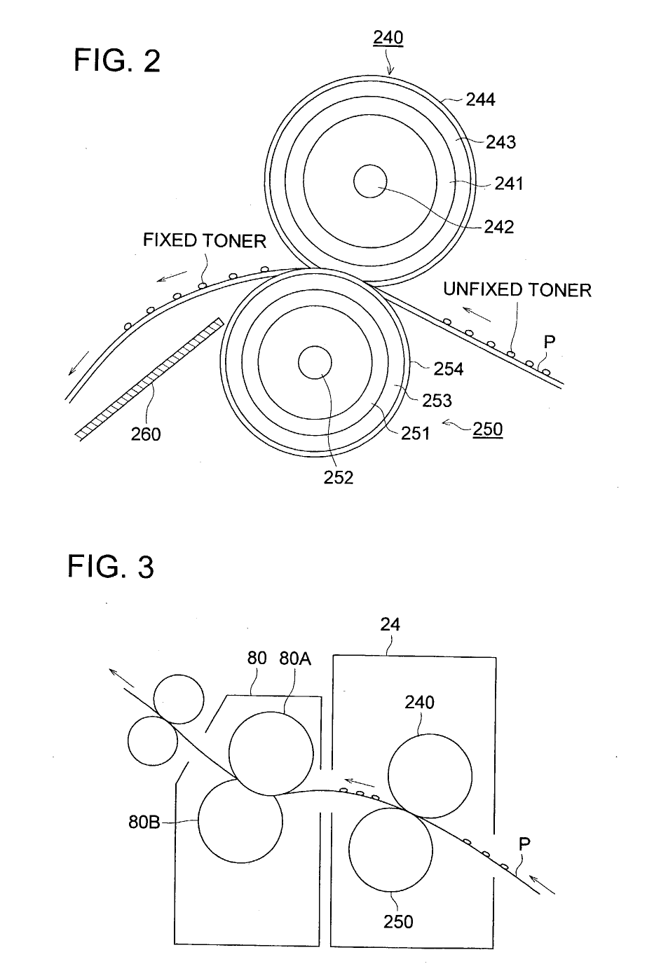

The following describes the fixing device of the present invention with reference to a cross sectional view given in FIG. 2.

We have designed a fixing device including (1) a heat roller 240 provided with a cylindrical core 241 with a heating source 242 provided inside, an elastic body 243 lined around the core 241, and a mold releasing layer 244 covering the surface of the elastic body 243, and (2) a pressure roller 250 in pressure contact with the heat roller 240. In the fixing device, toner image is fixed by sandwiching, heating and pressurizing of the transfer material where the unfixed toner image fed to the pressed nips of the two aforementioned rollers is transferred. Here the hardness of the aforementioned pressure roller 250 is set higher than that of the heat roller 240, and the difference in Asker C hardness is set from 10 to 15°. The has resulted in complete elimination of winding of a transfer material into the heat roller 240 and pressure roller 250 in pressure contact with the heat roller due to separation failure. Especially to avoid winding into the heat roller 240, the transfer material P curled to be convex upward. If the degree of curling is too big, however, it is not preferred in terms of practical use and handling. It is still less preferred in copying on the backside in duplexing mode because of possible winding into the photoconductors 1Y, 1M, 1C and 1K. To solve the problem, a flattener 80 as a curl correcting device is provided downstream of the fixing device 24, as shown in the cross sectional view of FIG. 3, and the hardness relationship between an upper roller and a lower roller is reversed to that of the two rollers of the fixing device 24. This makes it possible to obtain a flattened transfer material at the ejection tray 26.

As described above, a difference in product hardness is provided between the heat roller and the pressure roller to get a convex form upward and to eliminate the necessity of using oil, thereby ensuring satisfactory separation and cutting down the per-sheet cost. A paper curl caused by convex form upward is corrected by turning the curl of the transfer material P back to the reverse side by means of the flattener 80 which makes the transfer material to curl to be convex downward, as explained above. The method provides stable supply of comparatively flat print images characterized by satisfactory separation from the image carrier in the backside transfer mode and stable images transferred on both the front and back sides, free from curling on the transfer material.

### EXAMPLE

The heat roller 240 has a silicone rubber layer provided on the core 241 as an elastic body 243, and coating or tubing of fluororesin (PFA) was provided thereon as a mold releasing layer 244. The Asker C hardness was 74°, and a halogen heater lamp is arranged as a heating source 242 inside the core 241. A temperature sensor was provided on the surface of the heat roller 240, and the detected temperature thereof was used to control the lamp output.

The pressure roller 250 has a silicone rubber layer provided as elastic body 253 on the core 251, and coating or tubing of fluororesin (PFA) was provided thereon as a mold releasing layer 254. The Asker C hardness was 86°, and a halogen heater lamp was arranged as a heating source 252 inside the core 251. A temperature sensor was provided on the surface of the pressure roller 250, and the detected temperature thereof was used to control the lamp output.

Waxed styrene acryl polymerized toner (St-Ac polymerized toner) of low melting point was used as toner. Silicone oil was not used to assist separation.

The conveyance speed of the transfer material at the time of fixing was at 220 mm per second.

The KONICA J paper (64 g/m²) was used as transfer material as normal paper in thickness and Prince (R) of OK Company having a basis weight of 220 g/m² was used as thicker paper.

Further, a flattener 80 was installed downstream of the fixing device 24 in the transfer material conveyance direction as a curl correcting device having a curve to be convex downward, which is constituted by a lower roller 80B formed on a metal core that is soft and made of sponge rubber such as silicone or urethane, and an upper roller 80A that is hard and made of metal.

As described above, since the flattener 80 as a curl correcting device was installed downstream of the fixing device 24, the curl of the transfer material having a curve to be convex upward can be corrected by making the transfer material to pass through the fixing device 24 constituted by the heat roller 240 and the pressure roller 250 that is harder than the heat roller 240.

As described above, the hardness of the pressure roller 250 was set higher than that of the heat roller 240, and the difference in Asker C hardness was set at 12°. Image forming operation of 100,000 sheets was performed to check for winding around both rollers. Not a single sheet was found to be wound, and satisfactory results were recorded. It should be noted that the aforementioned product hardness is not restricted to 12°. Results as good as those at 12° were obtained if the hardness is within the range from 10 to 15°.

When a difference of the product hardness was less than 10°, there sometimes occurred phenomena wherein a sheet of paper wound around the heat roller 240 when solid images were formed on the KONICA J paper (64 g/m²). When a difference of the product hardness was greater than 150, there sometimes occurred problems that a sheet of paper curled to be convex upward remarkably to creep into a space between the pressure roller 250 and sheet guide plate 260 (shown in FIG. 2), when images having a small ratio of colored area were formed on the KONICA J paper (64 g/m²)

Even when a separation claw is brought into contact with the heat roller 240 and the pressure roller 250 for the problem mentioned above, the heat roller 240 and the pressure roller 250 are scratched by the claw, resulting in the phenomenon of uneven gloss on color images, although paper jam can be avoided. Only when a difference of the product hardness was in a range of 10°-15°, silicone oil was not required and image deterioration was not caused, and excellent sheet-threading efficiency was obtained.

The fixing device according to the fixing device of the present invention and image forming apparatus equipped therewith eliminate the necessity of using an oil coating device having an oil roller. There is no winding of transfer material around the heat roller and heat roller due to separation failure at the time of fixing. They provide easy handling without the images being contaminated, a high degree of stable fixing performances, reduced per-sheet printing cost, and reduce the machine cost.

What is claimed is:

1. A fixing device comprising;
(a) a heat roller having a cylindrical core with a heating source provided inside, an elastic body lined around the core, and a mold releasing layer covering a surface of the elastic body; and
(b) a pressure roller kept in pressure contact with the heat roller;
wherein an unfixed toner image on a transfer material is fixed by conveying and interposing the transfer material to a nip portion formed between the heat roller and the pressure roller, and
wherein hardness of the pressure roller is set higher than that of the heat roller, and a difference in Asker C hardness is set from 10 to 15°.

2. An image forming apparatus comprising the fixing device of claim 1.

3. The image forming apparatus of claim 2, further comprising a sheet curl correction device provided downstream of the fixing device for making the transfer material which has passed through the fixing device, to curl to be convex downward.

4. The image forming apparatus of claim 3, wherein the sheet curl correction device comprises an upper roller and a lower roller that is kept in pressure contact with the upper roller, and hardness of the upper roller is set higher than that of the lower roller.
